(19) United States
(12) Patent Application Publication
(10) Pub. No.: US 2013/0135568 A1
(43) Pub. Date: May 30, 2013

(54) CHOLESTERIC LIQUID CRYSTAL DISPLAY DEVICE WITH NON-UNIFORMLY REFLECTING LAYER

(71) Applicants: David Coates, Wimbourne (GB); Tony Orlando Alkins, Harrow (GB)

(72) Inventors: David Coates, Wimbourne (GB); Tony Orlando Alkins, Harrow (GB)

(21) Appl. No.: 13/704,826

(22) PCT Filed: Jun. 8, 2011
(86) PCT No.: PCT/GB2011/000867

§ 371 Date: Jan. 30, 2013

(30) Foreign Application Priority Data
Jun. 17, 2010 (GB) 1010211.9

(51) Int. Cl. G02F 1/1335

(52) U.S. Cl. CPC G02F 1/133553; G02F 1/133514
USPC 349/106; 349/113

(57) ABSTRACT

A cholesteric liquid crystal display device (10) comprises a layer of cholesteric liquid crystal material (11) supported by at least one substrate (13; electrode layers (14,15) on opposite sides of the layer of cholesteric liquid crystal material (11); and a light absorptive or reflective layer (17) on the rear side of the layer of cholesteric liquid crystal material (11). To provide non-uniform reflection of light, there is a layer (18) of reflective flakes (19) on the front side of the light absorptive or reflective layer (17), or the reflective layer is shaped to be non-planar.

The present invention relates to the provision of a decorative panel.

There is a commercial demand for decorative panels in many manufactured products. By way of example, one type of product in which a decorative panel may be used is the casing for a portable electronic device such as a mobile telephone or music player. In this field, there is a large after-market in the casings used to protect and personalise the portable electronics device. The present invention is concerned generally with technical means for making a decorative panel attractive.

According to the present invention, there is provided a cholesteric liquid crystal display device that may serve as a decorative panel. Such a cholesteric liquid crystal device might typically comprise: a layer of cholesteric liquid crystal material supported by at least one substrate; electrode layers on opposite sides of the layer of cholesteric liquid crystal material; and a light absorptive or reflective layer on the rear side of the layer of cholesteric liquid crystal material.

In such a device, the cholesteric liquid crystal material may be used to provide a decorative appearance. Cholesteric liquid crystal material has stable states between which its appearance differs. In particular, the cholesteric liquid crystal material has a stable focal state and a stable planar state. In the stable planar state, the cholesteric liquid crystal material is reflective. The range of wavelengths reflected may be controlled by selection of the properties of the material. In the stable focal conic state, the material mainly transmits light that is then absorbed or reflected by the light absorptive or reflective layer on its rearside. Thus, the cholesteric liquid crystal material display device has a different appearance depending on the state of the cholesteric liquid crystal material. This state may be controlled by applying drive signals across the electrode layers.

Thus, the appearance is governed by the properties of the liquid crystal material, the shape of the electrode layers and the drive signals applied thereto, as well as by the design of the light absorptive or reflective layer. By selection of these factors, the cholesteric liquid crystal display device may provide a variety of decorative designs. Furthermore, as power is only consumed to change the state of the cholesteric liquid crystal material between these stable states, the power consumption is reduced as compared to the use of liquid crystal materials and devices that use non-stable states, for example twisted nematic liquid crystal displays.

The present invention is not dependent on the aesthetic quality of the cholesteric liquid crystal display device as such, aesthetics being of course subjective. However, the present invention is concerned with the technical construction of the cholesteric liquid crystal display device that allows the decorative appearance to be changed, thus providing the means to provide new designs at the creative control of the designer.

According to the present invention, the decorative appearance of the cholesteric liquid crystal device is changed by further providing that the layer of the cholesteric liquid crystal display device is arranged to provide non-uniform reflection of light. Aspects of the invention are concerned with the technical manner in which this is achieved, as follows.

According to a first aspect of the present invention, the cholesteric liquid crystal display device further comprises a layer of reflective flakes on the front side of the light absorptive or reflective layer.

The reflective flakes change the appearance of the cholesteric liquid crystal display device for use as a decorative panel. As the flakes are arranged on the front side of the light absorptive or reflective layer, some of the incident light is reflected from those reflected from the flakes, rather than the light absorptive or reflective layer. This changes the appearance of the cholesteric liquid crystal display device in the region where the reflective flakes are provided. The reflection from the reflective flakes is therefore eye-catching in a manner that many people would describe as attractive or interesting. Typically, the reflection from the reflective flakes may vary depending on the angle of incidence of illuminating light and the viewing angle of the viewer. This effect can cause the reflective flakes to appear to sparkle as the orientation of the cholesteric liquid crystal device chance, for example when it is handled. This sparkling effect is enhanced when the flakes lie in slightly different orientations relative to the planar cholesteric liquid crystal display device, so that light is reflected from different reflective flakes as these angles change.

Advantageously, the layer of reflective flakes is arranged on the rear side of the layer of cholesteric liquid crystal material. In this case, the appearance of the reflective flakes changes depending on the state of the cholesteric liquid crystal material. In particular, the spectrum of light that is incident on the reflective flakes changes depending on the state of the cholesteric liquid crystal material, which in turn causes the spectrum of light reflected from the reflective flakes to change depending on the state of the cholesteric liquid crystal material. This means that the state of the cholesteric liquid crystal material changes the appearance of the reflective flakes to the viewer, as well as changing the appearance of the remaining areas of the cholesteric liquid crystal display device where the flakes are not present. This technical effect further changes the appearance of the cholesteric liquid crystal display device, as compared to the alternative situation that the layer of reflective flakes is provided on the front side of the layer of cholesteric liquid crystal material. In that alternative, the light reflected from the reflective flakes is unaffected by the state of the cholesteric liquid crystal material.

According to a second aspect of the present invention, non-uniform reflection of light, the cholesteric liquid crystal display device is provided with a reflective layer, rather than a light absorptive layer, and the reflective layer is shaped to be non-planar.

In this case, light is reflected from the reflective layer at differing angles in different regions. This changes the appearance of the cholesteric liquid crystal display across its area. This allows the cholesteric liquid crystal display device to be provided with an increased decorative appearance, depending on the shape of the reflective layer that may be designed under the creative control of a designer. For example, the reflective layer may be shaped with pitted areas, which may be of the same or varying sizes, providing a pattern which many viewers would describe as attractive or interesting. Another example is that the reflective layer is shaped with graphical elements such as pictures, characters, or symbols, for example a brand logo.

To allow better understanding, embodiments of the present invention will now be described by way of non-limitative example with reference to the accompanying drawings, in which:

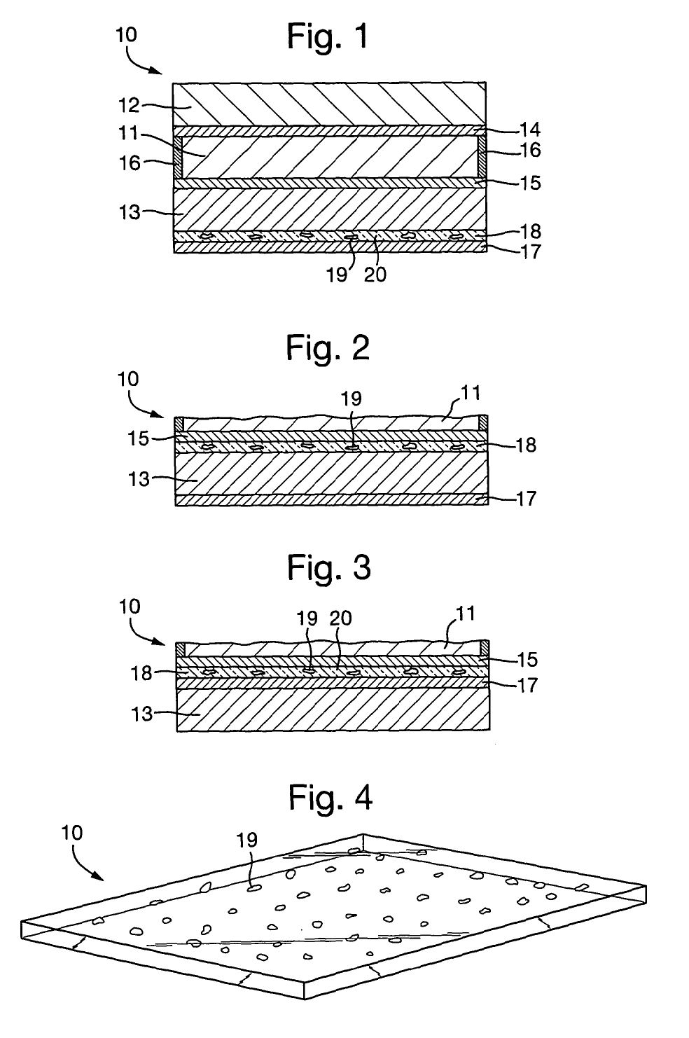

FIG. 1 is a cross-sectional view of a display device;

FIGS. 2 and 3 are partial cross-sectional views of the rear part of the display device in an alternative arrangement;

FIG. 4 is a perspective view of the display device;

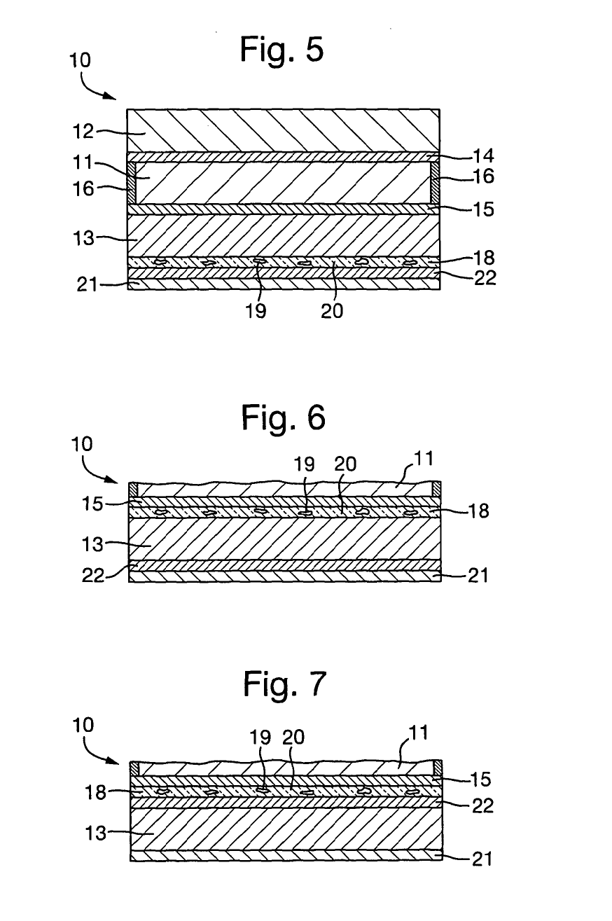

FIG. 5 is a cross-sectional view of the display device in a modified form;

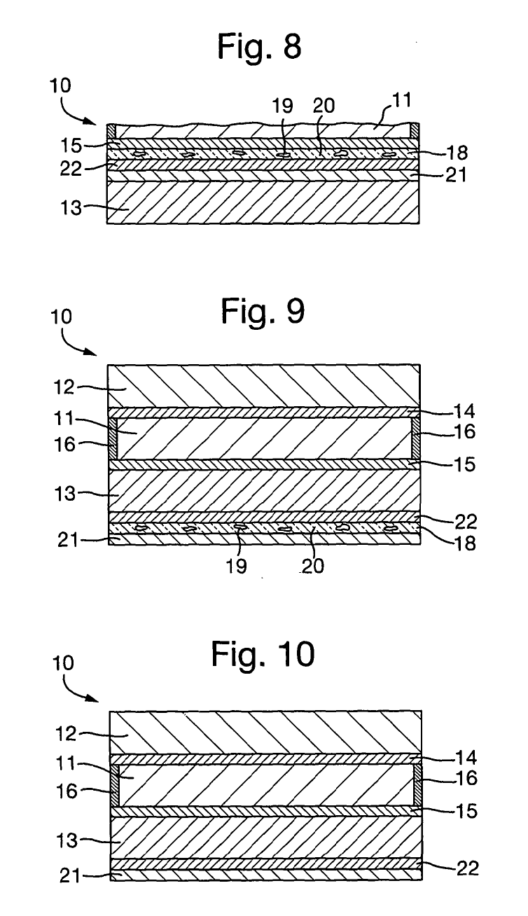

FIGS. 6 to 8 are partial cross-sectional views of the rear part of the display device in an alternative arrangement of the modified form;

FIG. 9 is a cross-sectional view of the display device in a further alternative arrangement of the modified form;

FIG. 10 is a cross-sectional view of the display device in a further modified form;

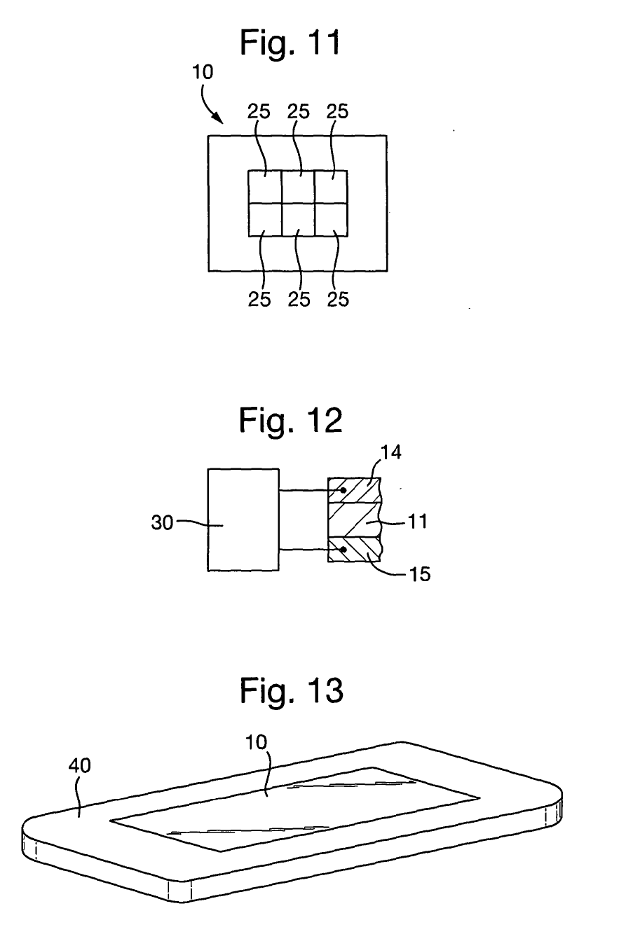

FIG. 11 is a front view of the display device showing areas defined thereon;

FIG. 12 is a diagram of a control circuit; and

FIG. 13 is a perspective view of a casing incorporating the display device.

A cholesteric liquid crystal display device 10 that may be used as a decorative panel is shown in FIG. 1. The display device has a layered construction consisting of plural layers that are described further below and that are shown in FIG. 1 with a thickness that is exaggerated for clarity.

The display device 10 comprises a liquid crystal layer 11 that is a layer of liquid crystal material. The liquid crystal material 11 is supported by two substrates 12 and 13 arranged on opposite sides of the liquid crystal layer 11 to define there between a cavity in which the liquid crystal layer 11 is contained. The liquid crystal layer 11 may be sealed in the cavity between the substrate 12 and 13 by providing a glue seal 16 around the perimeter of the liquid crystal layer 11. The substrates 12 and 13 are sufficiently rigid to support the liquid crystal layer 11, although they may have a degree of flexibility. For example, the substrates 12 and 13 may be made of glass or plastic. Electrode layers 14 and 15 are disposed on the respective substrate 12 and 13, in particular on the inner facing surfaces of the substrates 12 and 13 between those substrates 12 and 13 and the liquid crystal layer 11. The electrode layers 14 and 15 are transparent and conductive, being formed of a suitable transparent conductive material, typically indium tin oxide. As described further below, the electrode layers 14 and 15 may extend across part or all of the area of the display device 10, and may be patterned to provide separate pixels.

Optionally, the electrodes 14 and 15 may be overcoated, on the side adjacent to the liquid crystal layer 11, by one or more insulation layers (not shown), for example made of silicon dioxide.

Additionally or alternatively, the electrode layers 14 or 15 may be covered by respective alignment layers (not shown) formed adjacent the liquid crystal layer 11 and covering the electrode layers 14 and 15 or the insulation layers if provided. Such alignment layers align and stabilise the liquid crystal layer and may typically be made of polyimide which may optionally be unidirectionally rubbed. As an alternative to such surface-stabilisation using alignment layers, the liquid crystal layer could be bulk-stabilised, for example using a polymer or a silica particle matrix.

The liquid crystal layer 11 has a thickness chosen to provide sufficient reflection of light, typically being in the range from 3 μm to 10 μm. This thickness is selected by controlling the thickness between the substrate 12 and 13, typically by the provision of spacers (not shown) within the liquid crystal layer 11.

The front substrate 12 (uppermost in FIG. 1) is on the front side of the cholesteric liquid crystal display device 10, being the side on which light is incident and from which the display device 10 is viewed. The rear substrate 13 also supports an absorptive layer 17, in this case being supported via a speckle layer 18 described in more detail below.

The absorptive layer 17 is arranged to absorb at least some of the light that is incident thereon, i.e. light that has not been reflected by the liquid crystal layer 11 if the liquid crystal layer is in the planar state. The absorptive layer 17 may be black so that it substantially absorbs all the incident light. Alternatively, the absorptive layer 17 may be coloured so that it absorbs light of some wavelengths preferentially to other wavelengths. Thus, the absorptive layer 17 may reflect some of the incident light, in which case it preferably acts as a diffuse reflector of light.

The absorptive layer 17 may be formed by any suitable material, for example as a layer of paint, or more generally any layer of binder material containing pigments for the absorption of light, or for example as a layer of material such as a polymer.

The liquid crystal layer 11 comprises cholesteric liquid crystal material. Such material has several physical states in which the reflectivity and transmissivity vary. These states are the planar state, the focal conic state and the homeotropic (pseudo nematic) state, as described in I. Sage, Liquid Crystals Applications and Uses, Editor B Bahadur, Vol. 3, 1992, World Scientific, pp 301-343 which is incorporated herein by reference and the teachings of which may be applied to the present invention.

In the planar state, the liquid crystal layer 11 selectively reflects a bandwidth of light that is incident upon it. The reflectance spectrum of the liquid crystal layer 11 in the planar state typically has a central band of wavelengths in which the reflectance of light is substantially constant.

The wavelength λ of the reflected light are given by Bragg's law, i.e. λ=nP, where n is the mean refractive index of the liquid crystal material seen by the light and P is the pitch length of the liquid crystal material. Thus, in principle, any colour can be reflected as a design choice by selection of the properties of the of the liquid crystal material, in particular the pitch length P. That being said, a number of further factors known to the skilled person may be taken into account to determine the exact colour.

The planar state is used as the bright state of the display device 10 and the viewer sees the light reflected from the liquid crystal layer 11. When the liquid crystal material is in the planar state, light not reflected from the liquid crystal layer 11 is incident on the absorptive layer 17. If the absorptive layer 17 is black, it absorbs substantially all the light incident thereon and the viewer sees just the light reflected from the liquid crystal layer 11. If the absorptive layer 17 is coloured, it absorbs light incident light of some wavelengths but reflects light of other wavelengths. The light reflected from the absorptive layer 17 is seen by the viewer in addition to the light reflected from the liquid crystal layer 11 and may change the perceived colour.

In the focal conic state, the liquid crystal layer 11 is, relative to the planar state, transmissive and transmits incident light. Strictly speaking, the liquid crystal layer 11 is mildly light scattering with a small reflectance, typically of the order of 1% or less. All the incident light is incident on the absorptive layer 17 which absorbs at least some of the incident light. When the liquid crystal layer 11 is in the focal conic state, the viewer sees any light reflected from the absorptive layer 17 and thus perceives the display device 10 as being of the colour of the absorptive layer 17, this being a darker state than when the liquid crystal layer 11 is in the planar state.

The focal conic and planar states are stable states which can coexist when no drive signal is applied to the liquid crystal layer 11. Furthermore the liquid crystal layer 11 can exist in stable states in which different domains of the liquid crystal material are each in a respective one of the focal conic state and the planar state. These are sometimes referred to as mixture states. In these mixture states, the liquid crystal material has a reflectance intermediate the reflectances of the focal conic and planar states. A range of such stable states is possible with different mixtures of the amount of liquid crystal in each of the focal conic and planar states so that the overall reflectance of the liquid crystal material varies, thus giving a range of grey levels, although these are not necessarily used.

The focal conic, planar and mixed states are stable states that persist after the drive signal is removed. Thus the drive signal need only be applied to drive the liquid crystal layer 11 into one of the stable states. Thus, use of the stable states provides the display device 10 with a low power consumption.

In the homeotropic state, the liquid crystal layer 11 is even more transmissive than in the focal conic state, typically having a reflectance of the order of 0.6% or less. However, the homeotropic state is not stable and so maintenance of the homeotropic state would require continued application of a drive signal. To reduce power consumption, the planar state, rather than the homeotropic state, is preferably used as the persistent bright state, although the liquid crystal may pass through the homeotropic state when driven into the planar and/or focal conic state, depending on the drive scheme used for the drive signals applied to the electrode layers 14 and 15.

The speckle layer 18 has the effect of providing non-uniform reflection of light and is therefore provided on the front side of the absorptive layer 17, in this particular case being deposited on the substrate 13 with the absorptive layer 17 deposited thereon.

The speckle layer 18 is a layer of reflective flakes 19 contained in a layer of transparent material 20. The transparent material 20 may be any suitable material. For example, the transparent material 20 may be a resin, in which case the speckle layer 18 may be formed by depositing the reflective flakes 19 in the resin in its viscous liquid state and subsequently curing the resin to set the reflective flakes 19 in place.

Advantageously, the reflective flakes 19 are disposed within the speckle layer 18 in differing orientations relative to the plane of the liquid crystal layer 11. This may be achieved naturally when the reflective flakes 19 are applied to the display device 10.

The speckle layer 18 changes the appearance of the display device 10. In areas of the display device 10 where reflective flakes 19 are located the display device 10 is perceived as described above, in dependence on whether the liquid crystal material of the liquid crystal layer 11 is in the planar or focal conic state. In areas where the reflective layers 19 are present, light is reflected from those reflective flakes 19 thus providing a different appearance. In particular, the reflective flakes 19 provide the display device 10 with a speckled appearance. Consequently, the display device 10 has an appearance as shown in FIG. 4 in which the reflective flakes 19 are visible against the remainder of the display device 10.

Furthermore, specular reflection of light from the reflective flakes 19 causes the display device to appear to sparkle. The amount of light reflected is dependent on the angle of incidence of the incident light and on the viewing angle, and so changes when these angles change creating the sparkling effect, for example when the display device 10 is handled. This sparkling effect is increased by the reflective flakes 19 being arranged in differing orientations relative to the claim of the liquid crystal layer 11. In this case, the viewer sees light reflected from different reflective flakes 19 to the relative orientation of the display device 10 is changed.

The reflective flakes 19 may be formed from any suitable material. One example of the suitable material is a metal or a metallised foil. The metal that forms the flake or metallises the foil may, for example, be aluminium, gold or any other metal that is reflective, preferably one that is malleable. In this case, the metal may be anodised for example to provide the flakes with one or more colours. Another example of a suitable material is mica. In this case, the birefringent properties of mica create interference effects that are interesting to the viewer, particularly as the orientation of the display device 10 changes. Such flakes of mica may be treated to give different interference colours, for example by coating with an additional material such as titanium dioxide. These examples of materials are not limitative. The reflective flakes 19 may be made of two or more different material.

The reflective flakes 19 may be completely reflective on which case they may appear to be silver, or may be coloured with one or more colours.

The size and shape of the reflective flakes 19 may be varied according to the wishes of the designer to provide different decorative effects. Typically the flakes 19 may be planar in shape. Typically but without limitation the flakes may have the following dimensions. Typically the flakes 19 may have an average thickness that is less than their average width, measured perpendicular to the thickness. The flakes 19 may have an average width of at least 10 μm, optionally at least 50 μm. The flakes may have an average width of at most 1 cm, optionally at least 5 mm. For example, in one form the reflective flakes 19 can have an average width of around 100 μm and in another form the reflective flakes 19 can have an average width of around 1 mm. The reflective flakes 19 may have an average thickness of at least 10 μm. The reflective flakes 19 may have an average thickness of at most 100 μm. Typically, the reflective flakes 19 might have an average thickness in the range from 30 μm to 50 μm. Such averages in width and thickness may be taken over all the flakes 19. Where the thickness of individual flakes 19 varies, an average for each flake 19 may be taken over the area of the flake 19. Where the widths of individual flakes 19 vary in different directions (i.e. for non-circular flakes 19), an average may be taken for each flake 19 over different directions across the flake 19.

The distribution of the reflective flakes 19 may be varied at the wish of the designer to provide a desired decorative effect. Desirably, the reflective flakes 19 have spaces in between so that there remains some area of the display device 10 from which light is not reflected by the reflective flakes 19.

The position of the rearmost electrode 15, the speckle layer 18 and the absorptive layer 17 shown in FIG. 1 is not limitative and may be varied provided that the speckle layer 18 is arranged in front of the absorptive layer 17.

By way of example, FIG. 2 illustrates an alternative arrangement in which the speckle layer 18 is provided on the front side of the rear substrate 13. In this case, the rear electrode layer 15 is formed on top of the speckle layer 18. This is technically feasible, but has the disadvantage as compared to the arrangement of FIG. 1 that the speckle layer 18, and in particular the transparent material 20, needs to have its upper surface planarised to allow the deposition of a flat electrode layer 18.

In another example shown in FIG. 3, the absorptive layer 17 is also arranged on the front side of the rear substrate 13. This is a similar location for the absorptive layer 17 as disclosed in U.S. Pat. No. 6,753,937, the disclosure of which applies equally to the present invention and which is incorporated herein by reference.

In addition, in the alternative arrangements of FIGS. 2 and 3, the rear electrode layer 15 may alternatively be disposed behind the speckle layer 18 and/or the absorptive layer 17. In this case, the arrangement is similar to that disclosed in U.S. Pat. No. 6,788,362 and U.S. Pat. No. 7,195,813, the disclosures of which apply equally to the present invention and which are both incorporated herein by reference.

A modified form of the display device 10 is shown in FIG. 5. Apart from the modifications described below, the display device 10 in the modified form of FIG. 5 is identical to the display device 10 shown in FIG. 1 and described above. Accordingly, common reference numerals are used in respect of identical elements and for the sake of brevity a description thereof will not be repeated.

In the modified form of the display device 10, the absorptive layer 17 is replaced by a reflective layer 21 and a filter layer 22 constructed and arranged in a similar manner to that disclosed in U.S. Pat. No. 6,950,157, the disclosure of which applies to the present invention and which is incorporated herein by reference.

The reflective layer 21 reflects light that is incident thereon, rather than absorbing that light. The reflective layer 21 may provide specular reflection. The reflective layer 21 may have any suitable construction or material. By way of example, the reflective layer may be a foil of metal, for example aluminium.

The filter layer 22 is provided in front of the reflective layer 21, in this case between the speckle layer 18 and the reflective layer 21. The filter layer 22 provides a coloured filter. In particular, the filter layer 22 is arranged to have a relatively greater absorption of light of wavelength that are reflected by the liquid crystal material in its planar state than of light of other wavelengths. Ideally, the filter layer 22 would absorb an identical spectrum of wavelengths to the spectrum of wavelengths reflected by the liquid crystal material in its planar state. This ideal can be achieved approximately by selection of pigments for inclusion in the filter layer 22, but is difficult to achieve precisely.

The purpose of the modification to replace the absorptive layer 17 by the reflective layer 21 and the reflective layer 22 is to increase the brightness of the display device 10 in both the bright and dark states of the liquid crystal layer 11. This is because light of wavelengths that are not reflected by the liquid crystal layer 11 in its planar state is transmitted through the liquid crystal layer 11 and the filter layer 22, and reflected by the reflective layer 21, irrespective of the state of the liquid crystal layer 11. Thus, in any state of the liquid crystal layer 11, some light is reflected, in particular in that part of the spectrum which is not reflected by the liquid crystal layer 11 in its planar state.

The choice of the filter characteristic of the filter layer 22 with respect to the reflectivity of the liquid crystal layer 11 means that the bright state when the liquid crystal layer 11 is in the planar state is perceived by the viewer as being predominantly white. This is because the light that is not reflected by the liquid crystal layer 11 is transmitted through the filter layer 22 and reflected by the reflective layer 21. To the extent that the filter characteristic of the filter layer 22 does not match the reflection of the liquid crystal layer 11, the viewer might perceive the colour to be off-white.

In contrast, in the dark state in which the liquid crystal layer 11 is in the focal conic state, all the light passes through the liquid crystal layer 11, and the filter layer 22 absorbs light of some wavelengths but passes light of other wavelengths. The choice of the filter characteristic of the filter layer 22 means that the light transmitted by the filter layer 22 and reflected by the reflective layer 21 is of a colour that is complimentary to the colour reflected by the liquid crystal layer 11 in its planar state. This effect is described in further detail in U.S. Pat. No. 6,950,157.

The relative positions of the rearmost electrode 15, the speckle layer 18, the filter layer 22 and the reflective layer 21 shown in FIG. 1 are not limitative and may be varied provided that the speckle layer 18 and filter layer 22 are arranged in front of the reflective layer 21.

By way of example, FIGS. 6 to 8 illustrate alternative arrangements in which successive ones of the speckle layer 18, the filter layer 22 and the reflective layer 21 are moved to be provided on the front side of the rear substrate 13. In these cases, the rear electrode layer 15 is formed on top of the speckle layer 18. This is technically feasible, but has the disadvantage as compared to the arrangement of FIG. 5 that the speckle layer 18, and in particular the transparent material 20 needs to have its upper surface planarised to allow the deposition of a flat electrode layer 18.

In addition, in the alternative arrangements of FIGS. 6 to 8, the rear electrode layer 15 may alternatively be disposed behind the speckle layer 18, and/or the filter layer 22, and/or the reflective layer 21. In this case, the arrangement is similar to that disclosed in U.S. Pat. No. 6,788,362 and U.S. Pat. No. 7,195,813, the disclosures of which apply equally to the present invention and which are both incorporated herein by reference.

In addition, the order of the speckle layer 18 and the filter layer 22 maybe reversed. As an example of this, FIG. 9 illustrates an alternative arrangement of the modified form of the display device 10 shown in FIG. 5 in which the relative positions of the speckle layer 18 and the filter layer 22 are reversed. Similar reversal may be implemented in the alternative arrangements illustrated in FIGS. 6 to 8.

In the modified form of the display device 10 illustrated in FIG. 5, the effect of incorporating the speckle layer 18 is similar to that described above with respect to the display device 10 illustrated in FIG. 1. If the speckle layer 18 is provided in front of the filter layer 22, then the light reflected from the reflective flakes 19 themselves is identical to that described above as reference to the display device 10 shown in FIG. 1. Alternatively, if the speckle layer is provided behind the filter layer 22, then the colour of the light reflected from the reflective flakes 19 is further changed by the filtering effect of the filter layer 22 in accordance with its filter characteristic. However, in both cases, the provision of the speckle layer 18 to the rear of the liquid crystal layer 11 means that the colour of the light reflected from the reflective flakes 19 themselves changes in dependence on whether the liquid crystal layer 11 is in the planar state or the focal conic state.

A further modified form of the display device 10 is shown in FIG. 10. Apart from the modification described below, the display device 10 in the modified form of FIG. 10 is identical to the display device 10 shown in FIG. 1 and described above. Accordingly, common reference numerals are used in respect of identical elements and for the sake of brevity a description thereof will not be repeated.

In the further modified form of the display device 10 illustrated in FIG. 10, the absorptive layer 17 is replaced by a reflective layer 21 and a filter layer 22 that are arranged in the same manner as the reflective layer 21 and the filter layer 22 of the modified form of the display device illustrated in FIG. 5. The description thereof with reference to FIG. 5 applies equally to the further modified form of the display device 10 illustrated in FIG. 10 and for brevity that description will not be repeated.

In addition, the speckle layer 18 is omitted. However, an effect of providing non-uniform reflection of light is achieved by the reflective layer 21 being shaped to be non-planar. Such a non-planar shape causes light to be reflected from the reflective layer 22 at differing angles in different regions. This changes the appearance of the display device 10 across its area, thereby allowing the display device 10 to be provided with an increasedly new decorative appearance.

The non-planar shape of the reflective layer 22 may be freely designed under the creative control of a designer. For example, one option is for the reflective layer 22 to be shaped with pitted areas that may be of identical or varying sizes and may be arranged with regular or irregular spacing. Such an arrangement of pitted areas provides a pattern that is perceived by the viewer and that many people would describe as attractive or interesting. Another example is to shape the reflective layer 22 with graphical elements such as pictures, characters or symbols, for example a brand logo.

The shaping of the reflective layer 21 may be provided by any suitable means. For example, in the case that the reflective layer 21 is a foil of metal, then it may be shaped by embossing.

As described above, the following layers of the display device 10 may be changed by a designer to change the appearance of the display device 10:

the extent and arrangement of the electrode layers 14 and 15 which may be used to apply a drive signal to change the state of the area of the liquid crystal layer 11 across which the drive signals apply;

the colour of the absorptive layer 17;

the colour of the reflective layer 21; and/or

the extent and colour of the filter layer 22.

In the simplest form of the display device 10, these layers are the same across the entire area of the display device 10. Alternatively, any of these layers may be arranged to extend across part of the display device 10 or to provide a different effect in different areas of the display device 10. By way of example, FIG. 11 illustrates a display device 10 in which square areas 25 are illustrated across a partial area of the display device 10. Any of the layers mentioned above may be changed in any of these areas 25 to provide a variety of different effects in these areas 25. Of course, the simple arrangement of areas 25 shown in FIG. 11 is not limitative and in general the effects may be varied in areas of any shape and size under the control of the designer.

As described above, the state of the liquid crystal 11 may be changed by applying drive signals thereto. FIG. 12 illustrates a suitable circuit for measurement for achieving this. In particular, a control circuit 30 is connected across the electrode layers 14 and 15 on opposite side of the liquid crystal layer 11 (the other layers of the display device 10 being emitted in FIG. 12 for clarity). The control circuit 30 is arranged to generate drive signals for changing the state of the liquid crystal layer 11. Many different forms of drive signal are known for changing the state of cholesteric liquid crystal material and any such form of drive signal may be used in the present invention.

As an alternative to use of the control circuit 30, the liquid crystal layer 11, change of state of the liquid crystal layer 11 may be driven using an electro-active element connected to the electrode layers 14 and 15 and optionally also shearing of the liquid crystal layer 11, in the manner disclosed in GB-2,424,305, the teachings of which are applicable to the present invention and which is incorporated herein by reference.

The display device 10 may be used as a decorative panel in a variety of different applications. An example is shown in FIG. 13 which illustrates the display device 10 being incorporated into a casing 40 for a mobile electronic device such as a mobile telephone or music player. The casing 40 may be made form any suitable material, for example a polymer or leather. This example is by no means limitative and the display device 10 can be incorporated as a decorative panel into a wide range of other objects to personalise them, for example and without limitation laptop computer cases, and cases for electronic goods such as CD players, video recorders, cameras, radios, telephones, digital photo frames, clocks, and watches.

1.-2. (canceled)

3. A cholesteric liquid crystal display device comprising:
a layer of cholesteric liquid crystal material supported by at least one substrate;
electrode layers on opposite sides of the layer of cholesteric liquid crystal material;
a light absorptive or reflective layer on the rear side of the layer of cholesteric liquid crystal material; and
a layer of reflective flakes arranged on the front side of the light absorptive or reflective layer.

4. A cholesteric liquid crystal display device according to claim 2, wherein the layer of reflective flakes is arranged on the rear side of the layer of cholesteric liquid crystal material.

5. A cholesteric liquid crystal display device according to claim 2, wherein the flakes are disposed in differing orientations relative to the plane of the layer of liquid crystal material.

6. A cholesteric liquid crystal display device according to claim 2, wherein the flakes are planar.

7. A cholesteric liquid crystal display device according to claim 2, wherein the flakes have an average thickness that is less than their average width.

8. A cholesteric liquid crystal display device according to claim 2, wherein the flakes have an average width of at least 10 μm, optionally at least 50 μm.

9. A cholesteric liquid crystal display device according to claim 2, wherein the flakes have an average width at most 1 cm, optionally at most 5 mm.

10. A cholesteric liquid crystal display device according to claim 2, wherein the flakes have an average thickness of at least 10 μm.

11. A cholesteric liquid crystal display device according to claim 2, wherein the flakes have an average thickness of at most 100 μm.

12. A cholesteric liquid crystal display device according to claim 2, wherein the flakes comprise flakes of metal, for example aluminium, or metallised foil.

13. A cholesteric liquid crystal display device according to claim 11, wherein the flakes of metal are anodised.

14. A cholesteric liquid crystal display device according to claim 2, wherein the flakes comprise flakes of mica.

15. A cholesteric liquid crystal display device according to claim 2, wherein the flakes are coloured.

16. A cholesteric liquid crystal display device according to claim 2, wherein the layer of reflective flakes consists of a layer of transparent material containing the reflective flakes.

17. A cholesteric liquid crystal display device according to claim 16, wherein the transparent material is a resin.

18. A cholesteric liquid crystal display device according to claim 2, wherein the light absorptive or reflective layer is a light absorptive layer.

19. A cholesteric liquid crystal display device according to claim 18, wherein the light absorptive layer is arranged to absorb light of different colours in different areas.

20. A cholesteric liquid crystal display device according to claim 2, wherein the light absorptive or reflective layer is a reflective layer and the cholesteric liquid crystal display device further comprises a coloured filter layer disposed between the layer of cholesteric liquid crystal material and extending across part or all of the layer of cholesteric liquid crystal material.

21. A cholesteric liquid crystal display device according to claim 20, wherein the at least one substrate includes a rear substrate on the rear side of the layer of cholesteric liquid crystal material, the coloured filter layer and the layer of reflective flakes being arranged on the rear side of the rear substrate.

22. A cholesteric liquid crystal display device according to claim 20, wherein the coloured filter layer is arranged to have a relatively greater absorption of light of wavelengths that the layer of cholesteric liquid crystal material is arranged to reflect in its planar state, than of light of other wavelengths.

23. A cholesteric liquid crystal display device according to claim 20, wherein the reflective layer is arranged to reflect light of different colours in different areas and/or the coloured filter layer is arranged to absorb light of different colours in different areas.

24. A cholesteric liquid crystal display device according to claim 2, wherein the layer of cholesteric liquid crystal material is supported by two substrates on opposite sides of the layer of cholesteric liquid crystal material.

25. A cholesteric liquid crystal display device according to claim 24, wherein the electrode layers are disposed on the respective substrates.

26. A cholesteric liquid crystal display device according to claim 25, wherein the electrode layers are disposed between the substrates and the layer of cholesteric liquid crystal material.

27. A casing for a mobile electronic device incorporating a cholesteric liquid crystal display device according to claim 2.

28-42. (canceled)
